(19) United States
(12) Patent Application Publication
(10) Pub. No.: US 2009/0180831 A1
(43) Pub. Date: Jul. 16, 2009

(54) Apparatus and method for tolerance stack-up compensation

(76) Inventor: Kenneth W. Kendall, Almont, MI (US)

Correspondence Address: BRANDON N. SKLAR. ESQ. (PATENT PROSECUTION);KAYE SCHOLER, LLP, 425 PARK AVENUE, NEW YORK, NY, 10022-3598, US

(21) Appl. No.: 12/007,519

(22) Filed: Jan. 11, 2008

(51) Int. Cl. F16B 5/02; F16B 39/10

(52) U.S. Cl. 403/408.1; 411/198

(57) ABSTRACT

Embodiments of the invention may include an apparatus and a method for accomplishing tolerance compensation of a fastener that secures a first member to a second member. The apparatus and method may include the use of a unitary insert that is received in a first opening of the first member. The unitary insert may define a slotted hole such that a mechanical fastener passes through the slotted hole and the first opening in the first member. The mechanical fastener may then attach to the second member. The tolerance compensation may be achieved by adjusting an orientation of the slotted hole with respect to the first member.

### FIELD OF THE INVENTION

Embodiments of the present invention relate generally to the compensation of open tolerance dimensions when mechanically fastening multiple objects.

### BACKGROUND OF THE INVENTION

When securing one object to another, errors in manufacturing or design may result in interferences, misalignment, and/or unacceptable gaps. As a consequence, designers typically allow for some tolerance when designing and specifying dimensions of an object. This tolerance is typically applied to an object through geometric dimensioning and tolerancing (“GD&T”), for example as defined in ASME Y14.5M-1994. Designers and engineers often balance the benefits of specifying very tight dimensioning against high cost of manufacturing objects to those very tight dimensions and tolerances. This often results in a mixture of dimensions and tolerances where only the most important dimensions are specified with tight dimensioning and tolerance requirements.

FIG. 1 schematically illustrates a plan view of a portion of an object 10 and a cross section of a conventional fastener 110 having a diameter of F. The diameter F has a tolerance off. The fastener 110 secures the object 10 by passing through an oversized through hole 120 with diameter H. The diameter H has a tolerance of h. The following equation outlines an equation for determining the placement tolerance or tolerance compensation T provided by the oversized through hole 120 shown in FIG. 1.

$$T = \frac{( ( H - h ) - ( F + f ) )}{2} \qquad Eq . 1 A$$

However, if the size of H and F are significantly larger than the tolerances h and f, Eq. 1A may be simplified to:

$$T = \frac{( H - F )}{2} \qquad Eq . 1 B$$

Referring to FIG. 1 and Eq. 1B, the placement tolerance T may be determined by subtracting the diameter F of the fastener 110 from the diameter H of the through hole 120. The result is then typically divided by two to give the placement tolerance T. When using Eq. 1B with a fastener pattern, increasing the diameter H of the through hole 120 results in greater latitude for errors in the bolt pattern placement. Alternatively, decreasing the diameter of the through hole 120 results in less latitude for error in the bolt pattern placement.

When securing one object to another using multiple fasteners, the resultant patterns of through holes and fasteners may stack up or result in constraints placed on the through hole and fastener patterns and the surrounding geometry, requiring the application of GD&T to the fastener pattern on each object. As the pattern increases in size or complexity, the GD&T may drive up the cost of manufacturing. Additionally, when using two or more independent patterns which were not originally intended to be used in conjunction or were perhaps designed and dimensioned to different design parameters, the result may include unreliable constraints on the dimensions between the patterns. For example, when attaching armored plating or panels to a military vehicle stationed in the field, the use of existing unrelated fastener patterns not intended for use together may be necessary.

In order to compensate for tight or complicated tolerancing or when two independent patterns are used in conjunction, compensation for unreliable constraints may be achieved using oversized features, such as increasing the diameter of the through hole. However, oversize features result in decreased interface performance between multiple objects.

Previous attempts have utilized a two-piece approach to inserts. U.S. Pat. No. 5,141,357 discloses a fastener insert that uses both an outer body member and an inner body member. U.S. Pat. No. 4,309,123 disclose a fastening member that is made of an interior bushing and an exterior bushing. Both these references suffer from the disadvantage of having multiple elements, resulting in additional part counts and complexity. Also, the use of a two-piece design requires additional tolerance considerations not only between the fastener and the insert and between the insert and the mounting plate, but also between the two pieces of the insert. Moreover, any two piece insert configuration results in additional engineering and manufacturing costs related with production, shipments, installation, and other such considerations.

### SUMMARY OF THE INVENTION

There exists a need to compensate for open GD&T and maintain interface performance. Embodiments of the invention include an apparatus and a method for tolerance compensation.

In one preferred embodiment, an apparatus may include a unitary member with a first surface, a second surface, and a side surface, such that the unitary member and a mechanical fastener may be configured to secure a first member to a second member. The side surface and the second surface of the unitary member may be at least partially received by a first opening in the first member. The unitary member may define a slotted hole passing from the first surface to the second surface. The slotted hole may be configured to receive the mechanical fastener such that the mechanical fastener passes through the slotted hole and the first opening to be secured to the second member. A compensation for the placement tolerance of the mechanical fastener may be achieved by adjusting an orientation of the slotted hole with respect to the first member.

In another preferred embodiment, a method for compensation tolerance may include forming a first opening in a first member. The method may include placing a unitary insert into the first opening of the first member. The method may include inserting the mechanical fastener into a slotted hole formed within the unitary insert. The method may include adjusting an orientation of the unitary member of the slotted hole with respect to the first member. The method may also include securing the mechanical fastener to the a second member.

In another preferred embodiment, an apparatus may include a first member, a second member, a mechanical fastener, and a unitary insert with a first surface, a second surface, and a side surface. The side surface and the second surface of the unitary member may be at least partially received by a first opening in the first member. The unitary member may define a slotted hole passing from the first surface to the second surface. The slotted hole may be configured to receive the mechanical fastener such that the mechanical fastener passes through the slotted hole and the first opening to be secured to the second member. A compensation for the placement tolerance of the mechanical fastener may be achieved by adjusting an orientation of the slotted hole with respect to the first member.

### BRIEF DESCRIPTION OF THE DRAWINGS

FIG. 1 illustrates a plan view of a conventional fastener of diameter F within an oversized thru hole of diameter H;

FIG. 2 illustrates an isometric view of a radial insert;

FIG. 3 illustrates a plan view of the radial insert of FIG. 2;

FIG. 4 illustrates a cross-sectional view of the radial insert taken along line A-A of FIG. 3;

FIG. 5 schematically illustrates the potential tolerance compensation associated with the radial insert of FIG. 2;

FIG. 6 schematically illustrates an isometric view of an example of four radial inserts used in a pattern of six mechanical fasteners; and

FIG. 7 illustrates a plan view of FIG. 6 showing the example of four radial inserts used in a pattern of six mechanical fasteners.

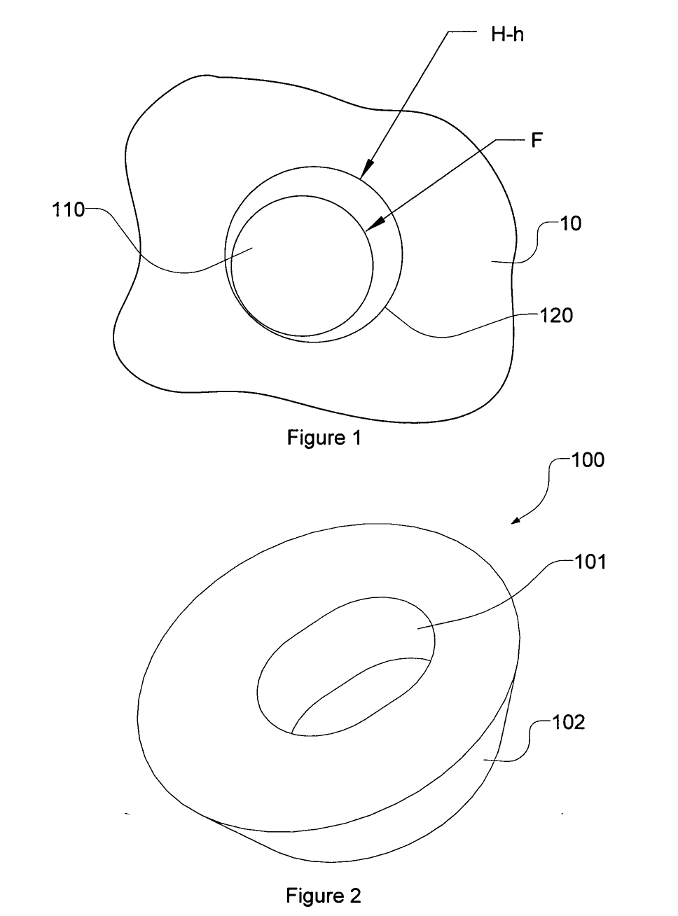

### DETAIL DESCRIPTION OF THE INVENTION

Generally, embodiments of the invention provide improved tolerance compensation and a method for mechanically fastening multiple objects. One embodiment of the invention includes a radial insert for mechanically connecting multiple objects using mechanical fasteners and through holes. The use of the radial inserts may be used to compensate for unreliable constraints between fastener and/or through hole elements on the objects. The radial insert and the methods disclosed herein may be implemented in connection with Geometric Dimension and Tolerance (“GD&T”). However, the radial insert may also be implemented in connection with other mechanically fastened objects to meet the design criteria of a particular application.

FIG. 2 illustrates an isometric view of a radial insert 100 forming a singular circular disk having a slotted hole 101 parallel to its central axis. The radial insert 100 may be a unitary member. The periphery of the circular disk may include a geometry configured to apply a clamp load. As an example, the side surface of the insert 100 may be configured with a predetermined taper 102 toward the interface between the two mechanically fastened objects. The taper 102 may assist in mechanically clamping one object to another when the location of the fasteners relative to each other is tightly or loosely constrained. The slotted hole 101 allows for the radial insert to compensate for a large tolerance stack-up when connecting more than one object using a pattern of mechanical fasteners. The slotted hole 101 may have a length longer than a width, or may be even shaped as an oval. As discussed in greater detail below, the predetermined taper on the periphery of the circular disk may provide a clamp load between two fastened objects, and may transfer shear between the interface of two objects into increased clamp load, effectively improving interface performance.

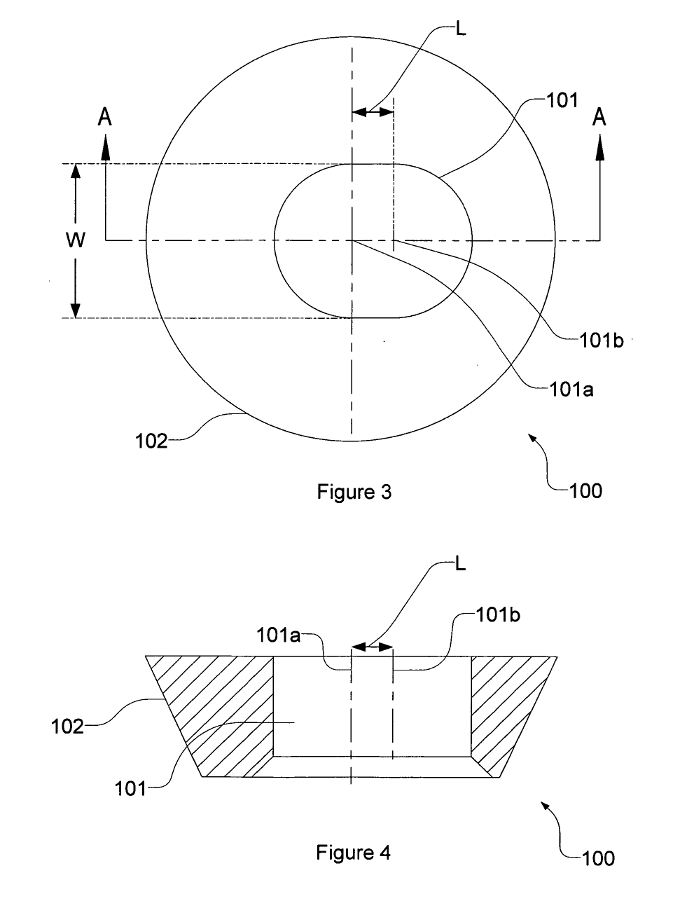

FIG. 3 and FIG. 4 illustrate a plan view and a cross-sectional view (taken along line A-A in FIG. 3), respectively, of the radial insert 100. As shown, the slot 101 includes a slot length L measured by the distance between axis 101a and axis 101b. Slot axis 101a shares the centerline of the radial insert 100. As shown in FIG. 3, the ends of the slot 101 may be circular or otherwise shaped to accommodate a fastener positioned at various locations along the slot length L between the axis 101a and axis 101b. The slotted hole 101 also includes a width W. The size of the radial insert, including the placement and size of the slot hole may be adjusted according to specific implementation design parameters.

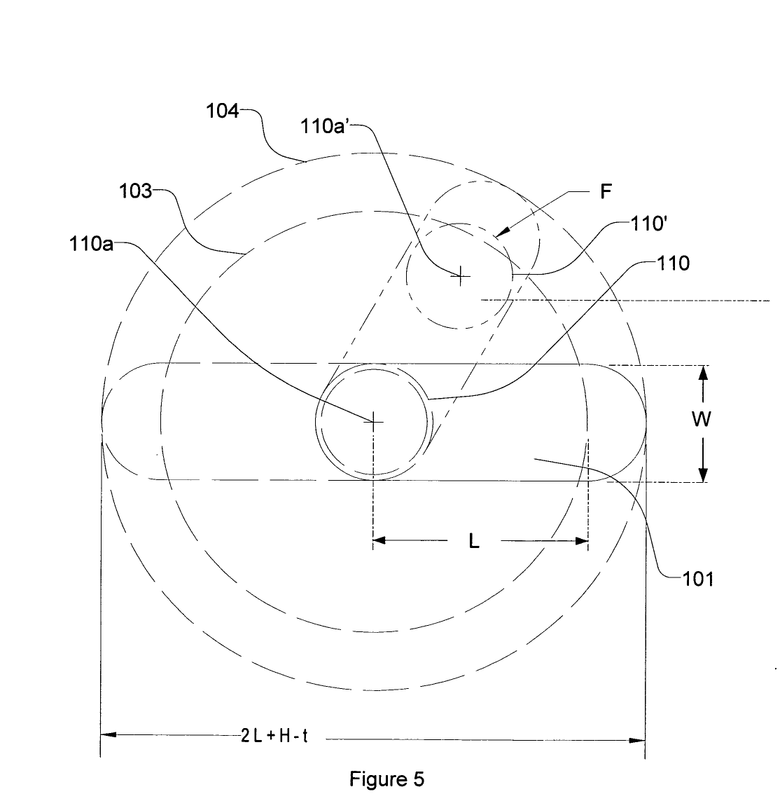

FIG. 5 schematically illustrates the potential tolerance compensation associated with the radial insert of FIG. 2. As shown in FIG. 5, the rotation of the slotted hole 101 (by rotation of the radial insert) about the axis 101a creates a circle 103, defined by the axis 101b, and a circle 104, defined by the physical end of the slotted hole 101. Circle 103 has a radius defined by the slot length L. By rotating the radial insert and moving the fastener 110 along the length of the slot 101, the axis 110a of the fastener 110 may be positioned anywhere on the circle 103 or any point within the circle 103. For example, as shown in FIG. 5, the fastener 110 is positioned in the center of the radial insert 100 such that the axis 110a of the fastener 110 is aligned with the axis 101a of the slotted hole 101. Additionally, the fastener may be positioned up and to the right hand side, shown in FIG. 5 as fastener 110′, such that the axis 101a′ is positioned off the center of the radial insert. The fastener 110′ position may be achieved simply by rotating the radial insert and sliding the fastener along the slotted hole 101.

Using the radial insert, the placement tolerance T for the fastener 110 in the slotted hole 101 may now be defined according to the following equation:

$$T = \frac{( 2 ( L - l ) + ( W - w ) - ( F + f ) )}{2} \qquad Eq . 2 A$$

wherein L has a tolerance 1, W has a tolerance w, and F has a tolerance f.

However, if the size of L, W, and F are significantly larger than the tolerances 1, w and f, Eq. 2A may be simplified to:

$$T = \frac{( 2 L + W - F )}{2} \qquad Eq . 2 B$$

When comparing Eq. 1B and Eq. 2B, in order for the traditional approach to match the placement tolerance in Eq. 2B (such that T of Eq. 1B is equal to T of Eq. 2B), the diameter H must be equal to 2L+W. Consequently, H must be much larger than the slotted hole 101 in order to accomplish the same placement tolerance. A hole, large enough to offer an equivalent placement tolerance as the radial insert 100, requires a large washer to cover the area of the hole. However, as one of ordinary skill in the art will appreciate, large holes require washers of increasingly large diameters and thickness to achieve the desired clamp performance.

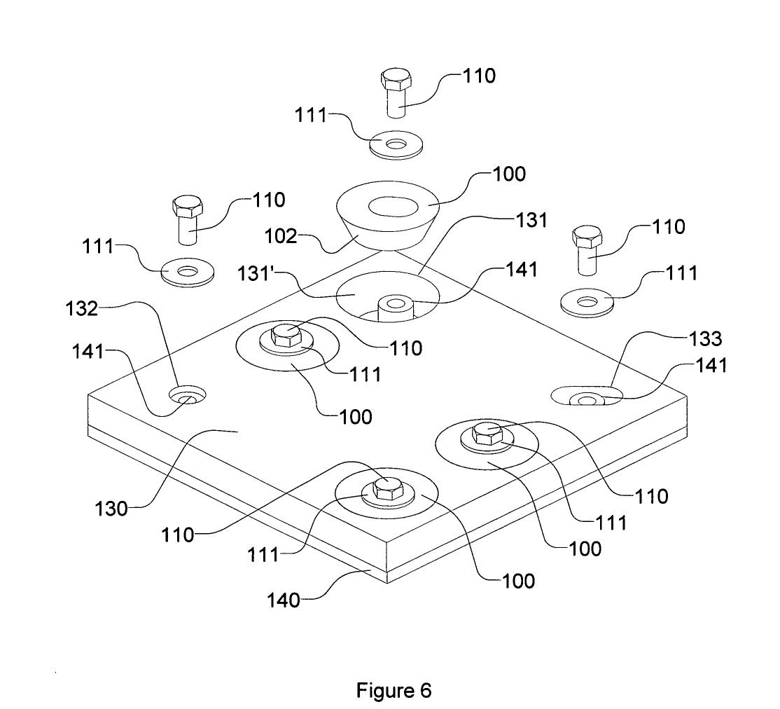

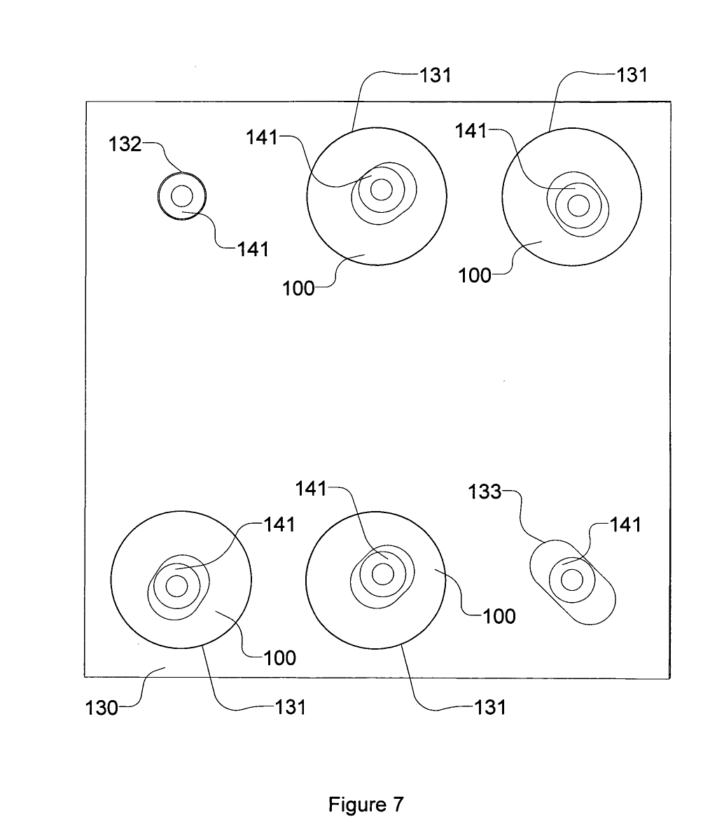

FIGS. 6 and 7 schematically illustrate an isometric view and a plan view, respectively, of an example of four radial inserts 100 used in a pattern of six mechanical fasteners. The radial inserts 100 provide a clamp load between a plate 130 and a panel 140. As an example, the plate 130 may include elements that are configured to be secured using a bolt pattern, such as an armored plate, machine base, or skid plate. Likewise, the plate 140 may include a portion of a vehicle or other such element that is configured to have the plate 130 bolted to it. In FIGS. 6 and 7, panel 140 may include a threaded hole pattern which, as shown in FIGS. 6 and 7, includes raised threaded holes 141 for receiving fasteners 110. The plate 130 has a 2-way locating hole 132 which constrains plate 130 to panel 140 axially but permits rotation. Plate 130 has a 1-way locating slot 133 which orients the plate 130 relative to panel 140 and restricts rotation of plate 130 about hole 132. Tapered holes 131 may be placed on plate 130 with respect to the threaded holes 141 on panel 140. It should be understood that a predetermined taper 131′ may be used with the holes 131 to approximately match the predetermined taper 102 on the radial insert 100. Upon securing the radial insert 100 and the plate 130 to the panel 140 using the fastener 110 and a washer 111, the taper 102 interfaces with the taper 131′ to provide a clamping load between the plate 130 and the panel 140.

During installation, a radial insert 100 may be placed in the tapered hole 131 and rotated until the slotted hole 101 fits over a threaded hole 141. The rotation of the radial insert 100 results in random radial orientation of the slot 101, allowing the radial insert to compensate for the open tolerance placement of the hole 131 and the threaded hole 141.

When the mechanical fasteners 110, such as bolts, screws, or other known mechanical fasteners, are tightened, they apply a clamp load on the radial insert 100 which in-turn applies a clamp load on the taper 131′ of plate 130. The clamp load applied to the taper 131′ ultimately constrains plate 130 to panel 140.

It is contemplated that, in the event that the plate 130 is forced in a direction normal to axis 101a, the predetermined taper 102 on the radial insert and the predetermined taper on the holes 131 may be configured to resist the lateral movement and force by reacting against the predetermined taper 102 on the radial insert 100. Such an arrangement may be configured to turn lateral movement into an increased tension in the mechanical fastener 110 or clamping force. Thus, the radial insert 100, when applied as shown in FIGS. 6 and 7 may improve interface performance between the plate 130 and the panel 140 by turning lateral movement or force into an increased clamp force between the plate 130 and the panel 140.

As an example, the radial insert shown in FIGS. 6 and 7 may be ⅞″ (2.22 cm) thick, with an upper diameter of 2.9″ (7.37 cm) and a lower diameter of 2.1″ (5.33 cm), effectively defining the taper of the periphery of the disk. The slotted hole may have a width of 1.1″ (2.79 cm) and a slot length L of 0.3″ (0.76 cm), with one end of the slotted hole aligned with the center axis of the circular disk.

It should be understood that the diameter of the hole 131 may vary in the example of plate 130 shown in FIGS. 6 and 7. So long as the taper 131′ operates with or approximately matches the taper 102, the overall diameter of the hole 131 becomes less significant. Although the plate 130 in FIGS. 6 and 7 includes the predetermined taper 131′, the hole 131 may also be configured without any taper 131′ so long as the diameter of the hole 131 is less than the largest diameter of the radial insert 100. In such situation, the taper 102 on the radial insert may still act to transfer a clamping force and act to turn any lateral movement or force into an increased clamp force between the plate 130 and the panel 140.

The radial insert may be used with alternative fastener patterns and fastener styles. For example, the raised threaded holes 141 shown in FIGS. 6 and 7 may alternatively include simple non-raised threaded holes into the panel 140 or even simple through holes, allowing for through bolts and threaded nuts to be used to apply a clamping force. Additionally, fastener 110 and the threaded holes 141 may be reversed, such that a threaded fastener may be welded or otherwise attached to the panel 140 extending up through the insert 100 and secured with a nut or other such threaded fastener.

It is also contemplated that the side surface of the radial insert 100 may include alternative arrangements. For example, the side surface of the insert may include a shoulder or step profile (not shown in the figures). The outer most diameter of the insert 100 may be configured to be larger than the hole in the panel, such that the shoulder or step rests on top of the panel. Although the hole in the panel does not have to match the step profile of the side surface of the insert, the hole and a matching step profile may alternatively be counter-sunk in the panel such that when the radial insert 100 with the step profile side surface is inserted into the hole, the top of the insert and the panel may be flush.

Additionally, although not shown in any figures, every fastener in a fastener pattern could employ an radial insert. For example, the holes 132 and 133, shown in FIGS. 6 and 7, could be replaced with holes 131 such that radial inserts 100 could be employed.

As an alternative, it is also contemplated that the placement of the radial insert 100 may be reversed such that the radial insert is attached to the permanent member, for example panel 140, instead of the removable member, for example panel 130. In such an alternative arrangement, the radial insert 100 could be set inside a welded ring with a captured nut, effectively reversing the role of the radial insert 100 as described above. As an example, when bolting an armored panel to a vehicle, the radial inserts 100 would be part of the vehicle instead of part of the armored panel.

Whereas the present invention is described herein with respect to specific embodiments thereof, it should be understood that various changes and modifications may be made by one skilled in the art without departing from the scope of the invention. It is intended that embodiments of the invention that encompass such changes and modifications fall within the scope of the appended claims.

What is claimed is:

1. An apparatus for tolerance compensation comprising:
a unitary member having a first surface, a second surface, and a side surface, the unitary member configured to secure a first member to a second member by a mechanical fastener;
the side surface and the second surface of the unitary member being at least partially received by a first opening in the first member; and
the unitary member defining a slotted hole passing from the first surface to the second surface, the slotted hole configured to receive the mechanical fastener such that the mechanical fastener is capable of passing through the slotted hole and the first opening, and is to be secured to the second member;
wherein compensation for the placement tolerance of the mechanical fastener is achieved by adjusting an orientation of the slotted hole with respect to the first member.

2. An apparatus according to claim 1, wherein the side surface of the unitary member is configured to apply a clamping force between the first member and the second member.

3. An apparatus according to claim 2, wherein the side surface of the unitary member has a predetermined taper.

4. An apparatus according to claim 3, wherein the predetermined taper of side surface of the unitary member matches a taper of the first opening in the first member.

5. An apparatus according to claim 3,wherein the unitary member is configured to convert sheer between the first member and the second member into increased tension in the mechanical fastener.

6. An apparatus according to claim 1, wherein the unitary member has a conical frustum shape.

7. An apparatus according to claim 1, wherein the slotted hole defines a slot length for accommodating the mechanical fastener at various locations along the slot length.

8. An apparatus according to claim 7, wherein an end of the slotted hole aligns with a center axis of the unitary insert.

9. A method of tolerance compensation comprises:
placing a unitary insert into a first opening of a first member;
inserting a mechanical fastener into a slotted hole formed within the unitary insert;
adjusting an orientation of the slotted hole of the unitary insert with respect to the first member; and
securing the mechanical fastener to a second member.

10. A method according to claim 9, wherein a side surface of the unitary insert has a predetermined taper.

11. A method according to claim 9, wherein the predetermined taper of the side surface matches a taper of the first opening of the first member.

12. A method according to claim 9, wherein the predetermined taper of the side surface provides a clamp load between the first member and the second member.

13. A method according to claim 9, wherein adjusting the orientation of the slotted hole allows the unitary insert to compensate for an open tolerance placement of the slotted hole with respect to the first member.

14. An apparatus comprising:
a first member;
a second member configured to be secured to the first member;
a mechanical fastener;
a unitary member having a first surface, a second surface, and a side surface, the unitary member and the mechanical fastener configured to secure the second member to the first member;
the side surface and the second surface of the unitary member being at least partially received by a first opening in the first member; and
the unitary member defining a slotted hole passing from the first surface to the second surface, the slotted hole configured to receive the mechanical fastener such that the mechanical fastener is capable of passing through the slotted hole and the first opening, and is to be secured to the second member;
wherein compensation for the placement tolerance of the mechanical fastener is achieved by adjusting an orientation of the slotted hole with respect to the first member.

15. An apparatus according to claim 14, wherein the side surface of the unitary member is configured to apply a clamping force between the first member and the second member.

16. An apparatus according to claim 15, wherein the side surface of the unitary member has a predetermined taper.

17. An apparatus according to claim 16, wherein the predetermined taper of side surface of the unitary member matches a taper of the first opening in the first member.

18. An apparatus according to claim 16,wherein the unitary member is configured to convert sheer between the first member and the second member into increased tension in the mechanical fastener.

19. An apparatus according to claim 14, wherein the unitary member has a conical frustum shape.

20. An apparatus according to claim 14, wherein the slotted hole defines a slot length for accommodating the mechanical fastener at various locations along the slot length.

21. An apparatus according to claim 20, wherein an end of the slotted hole aligns with a center axis of the unitary member.
